(19) United States
(12) Patent Application Publication
(10) Pub. No.: US 2025/0092234 A1
(43) Pub. Date: Mar. 20, 2025

(54) MICROMOLDING-BASED FABRICATION OF CHEMICALLY FUNCTIONAL AND STIMULI-RESPONSIVE OPAL MICROPARTICLES

(71) Applicant: Trustees of Tufts College, Medford, MA (US)

(72) Inventors: Hyunmin Yi, Lexington, MA (US); Subhash Kalidindi, Arlington, MA (US)

(21) Appl. No.: 18/889,713

(22) Filed: Sep. 19, 2024

Related U.S. Application Data
(60) Provisional application No. 63/539,263, filed on Sep. 19, 2023.

(51) Int. Cl. C08L 5/08

(52) U.S. Cl. CPC C08L 5/08; C08L 2207/53; C08L 2666/06

(57) ABSTRACT

Disclosed are microparticles comprising a polymeric core and chitosan. Also disclosed herein are methods of making the microparticles.

### RELATED APPLICATIONS

This application claims the benefit of priority to U.S. Provisional Application No: 63/539,263, filed Sep. 19, 2023.

### STATEMENT OF GOVERNMENT SUPPORT

This invention was made with government support under CBET-1703549 awarded by the National Science Foundation. The government has certain rights in the invention

### BACKGROUND

Opal microparticles have garnered significant attention in a broad range of important applications due to their utility as chemical and biological sensors, wound healing materials, anti-counterfeiting labels, and drug delivery systems. Substantial advances have been made in the fabrication techniques for opal microparticles, namely microfluidics, photolithography, soft lithography, and microscale printing techniques. While being a widely used and mature technique, microfluidic production of opal microparticles suffers from several limitations including the need for delicate control of microflows, harsh UV polymerization conditions that can limit the functionalization, and limited tunability of shapes and sizes. Another more commonly used technique is photolithography, which also faces several drawbacks such as time-consuming and complex multi-step processing steps, the need for harsh etching and surface treatment conditions, and expensive and extensive equipment needs. More recent techniques include microscale printing for the preparation of opal microparticles and microstructures. Microscale printing allows excellent control over organization of nanoparticles in ordered arrays to prepare 2-D microparticles but requires delicate control and expertise for uniform nanoparticle assembly through specialized masks at a controlled pressure on highly modified surfaces. On the other hand, soft-lithographic techniques such as imprint lithography and embossing can help overcome these limitations by offering simpler and less equipment-intensive routes for the preparation of opal microparticles. Despite these advantages, existing soft-lithographic techniques rely on external forces (e.g., capillary forces and/or external temperatures and pressures) and may lead to unreliable formation of uniform opal microparticles. Combined, there exists a critical need for a simple, reliable, and robust technique to fabricate opal microparticles.

### SUMMARY OF THE INVENTION

In one aspect, the present disclosure provides microparticles comprising a polymeric core and chitosan.

In another aspect, the present disclosure provides methods of making the micro-particles disclosed herein.

### BRIEF DESCRIPTION OF THE DRAWINGS

FIGS. 1A-1C show micromolding based evaporative deposition-neutralization technique for preparation of CS-opal microparticles. FIG. 1A shows a schematic diagram of the evaporation-neutralization technique. FIG. 1B is a photograph of a PDMS mold containing CS-opal micropatterns prepared via evaporative deposition. FIG. 1C is a photograph of CS-opal microparticles in a well of a 96-well plate.

FIG. 2A-2D show the evaporative deposition-neutralization technique for CS-opal micropatterns and microparticles. FIG. 2A shows photographs (left) and darkfield optical micrographs (right) of CS-opal micropatterns prepared using PS170, PS225 and PS260 beads from top to bottom. FIG. 2B shows photographs (left) and darkfield optical micrographs (right) of CS-opal microparticles prepared using the CS-opal micropatterns in FIG. 2A from top to bottom. FIG. 2C shows a UV-vis absorbance spectra of the CS-opal micropatterns and their respective CS-opal microparticles with diffraction peak wavelengths indicated using dashed lines. FIG. 2D shows a table comparing calculated PS bead diameters using Bragg-Snell's equation vs. measured PS bead sizes via DLS.

FIGS. 3A-3C show the morphology and profile of CS-opal microparticles via optical profilometry and SEM. FIG. 3A shows optical micrographs of 2D top view (top row) and 3D slanted view (middle row) of three different types of CS-opal microparticles made with varied PS bead sizes and their corresponding height profiles (bottom row). Yellow scale bars represent 20 μm. FIG. 3B is a SEM image showing multiple uniform CS-opal microparticles with uniform diameters. FIG. 3C shows a zoomed-in SEM image showing PS beads hexagonally assembled in FCC structure in the interior of a CS-opal microparticle. Inset: enlarged portion of FIG. 3C showing hexagonal packing.

FIG. 4 shows the stability of CS-opal microparticles upon incubation in extreme conditions. Darkfield optical micrographs of CS-opal microparticles upon exposure to: pH 0.1, pH 13.1, IPA, and 100° C.

FIGS. 5A-5C show the fluorescent labeling of CS-opal microparticles. FIG. 5A shows a schematic diagram of the labeling with CS-opal microparticles via acyl substitution reaction. FIG. 5B shows Darkfield optical micrographs (left) and the corresponding epifluorescence micrographs (right) of fluorescently labeled CS-opal microparticles prepared with varied CS content (0 to 0.12% w/v). FIG. 5C shows average fluorescence intensity vs. CS content obtained from the epifluorescence micrographs in FIG. 5B via image analysis.

FIGS. 6A-6C shows the spatially selective electroassembly of CS-opal microparticles. FIG. 6A shows a schematic diagram and a photograph of the electroassembled CS-opal microparticles on a patterned chip. FIG. 6B Darkfield optical micrographs showing CS-opal microparticles having varied CS contents (0 to 0.24% w/v) electroassembled on the patterned anode (left) and cathode (right). FIG. 6C number of electroassembled CS-opal microparticles on the patterned anode and cathode in FIG. 6B with increasing CS content.

FIGS. 7A-7D show the preparation of CS-IO microparticles. FIG. 7A shows a schematic diagram for the preparation of CS-IO microparticles via dissolution of PS beads in toluene. FIG. 7B shows darkfield optical micrographs showing uniform CS-IO microparticles from two separate batches. FIG. 7C shows zoomed-in SEM images of the CS-IO microparticles showing macroporous voids created upon dissolution of PS beads. FIG. 7D shows UV-Vis absorbance spectra of CS-opal microparticles and their corresponding CS-IO microparticles. Black arrow indicates the shift of the diffraction peak wavelength.

FIG. 8 shows the effect of neutralization with NaOH on preparation of CS-opal microparticles.

FIGS. 9A-9D show CS-opal microparticles with varied shapes. Darkfield micrographs showing PS230-based CS-opal microparticles with various shapes-square, circle, hexagon, and triangle (left to right side). FIG. 9A shows a darkfield micrograph of square PS230-based CS-opal microparticles. FIG. 9B shows a darkfield micrograph of circular PS230-based CS-opal microparticles. FIG. 9C shows a darkfield micrograph of hexagonal PS230-based CS-opal microparticles. FIG. 9D shows a darkfield micrograph of a triangular PS230-based CS-opal microparticles.

### DETAILED DESCRIPTION OF THE INVENTION

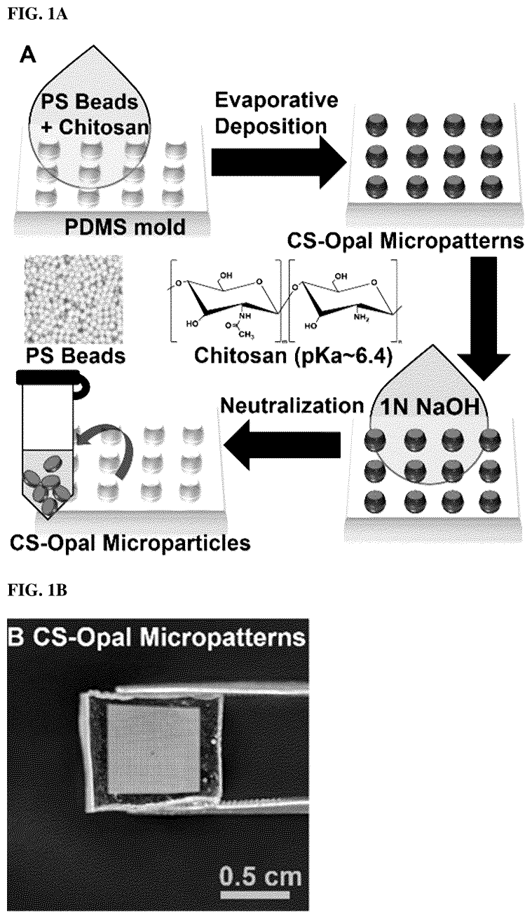

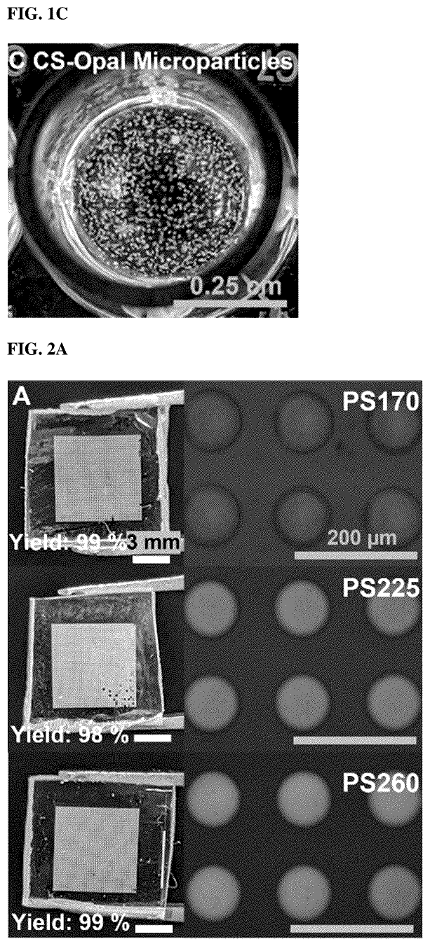

Our proposed solution to overcome these limitations is a simple micromolding-based evaporative deposition-neutralization method to prepare uniform opal microparticles containing a potent aminopolysaccharide chitosan (CS) as shown in the schematic diagram of FIG. 1A. CS is a naturally derived polysaccharide prepared by deacetylation of chitin, the second most abundant biopolymer comprising the shells of crustaceans. CS's abundant primary amine groups with low pKa (˜6.4) at each of its glucosamine monomer units make CS soluble at low pH rising from electrostatic repulsion between the positively charged amine groups. When CS is exposed to pH higher than the pKa, the amine groups become neutral allowing the formation of stable polymer networks. This simple and unique pH-responsive behavior of CS can be exploited to readily prepare various functional polymer scaffolds. CS's amine groups at a pH above its pKa (i.e. neutral state) also possess a highly nucleophilic pair of unshared electrons that can be enlisted for multiple amine-reactive conjugation chemistries making CS a potent conjugation handle. Further, at a pH lower than the pKa, the CS's amine groups become protonated making CS a cationic polyelectrolyte that is responsive to various stimuli including electric signals and pH. In short, CS is a potent and enabling biological polymer that can be harnessed for the preparation of chemically functional and stimuli-responsive polymeric platform materials for various applications.

In this report, we exploit these unique features to prepare stable and stimuli-responsive CS-opal microparticles. In our simple evaporation-neutralization method (FIG. 1A), an aqueous solution containing polystyrene nanoparticles (PS beads) and CS is first filled into patterned microwells. The water in the PS bead solution is then allowed to evaporate slowly allowing controlled assembly of PS beads into ordered hexagonal packing structures in each microwell to form uniform CS-opal micropatterns as shown in the photograph of FIG. 1B. Then, the CS-opal micropatterns are subjected to curing by simply adding IN sodium hydroxide (NaOH) onto the micropatterns, upon which uniform CS-opal microparticles are recovered as shown in the photograph of FIG. 1C.

Our results illustrate that our evaporation-neutralization method is a simple, robust, reliable and tunable route for high-yield production of uniform and stable CS-opal microparticles with controlled 2D shapes. Optical profilometry and scanning electron microscopy (SEM) results confirm the formation of highly uniform CS-opal microparticles consisting of close hexagonal packing of PS beads that are well preserved upon neutralization, showing the robust and reliable nature of our method. Upon incubation of the as-prepared CS-opal microparticles in extreme pH's and temperature as well as organic solvent, the CS-opal microparticles maintain their dimensions and uniform opalescent colors illustrating stable and robust nature. Next, simple fluorescence labeling of the CS-opal microparticles prepared with varied CS content confirms the chemical functionality of the primary amines of the CS as well as tunability. The pH-responsive CS-opal microparticles having varied CS content readily assemble in a spatially selective manner in response to electrical signal, illustrating a stimuli-responsive property. Finally, uniform and stable CS-inverse opal (IO) microparticles are successfully prepared by simply dissolving PS beads in toluene illustrating the stable and robust nature of the CS scaffolds. In sum, the results illustrate that our simple evaporation-neutralization method allows reliable and tunable preparation of stable, functional and stimuli-responsive CS-opal and CS-IO microparticles. It is envisioned that the simple micromolding-based fabrication approach reported in this study can be readily extended to prepare various engineering materials toward multiple applications including but not limited to anti-counterfeiting, biosensing and drug delivery.

In one aspect, the present disclosure provides microparticles comprising a polymeric core and chitosan.

In certain embodiments, the microparticle is the microparticle is spherical, cuboid, pyramidal, or a hexagonal prism.

In certain embodiments, the microparticle has a diameter of 50-1,000 μm. In certain embodiments, the microparticle has a diameter of 50-300 μm. In certain embodiments, the microparticle has a diameter of about 50 μm, about 60 μm, about 70 μm, about 80 μm, about 90 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, or about 300 μm. In certain embodiments, the microparticle has a diameter of about 170 μm, about 225 μm, or about 260 μm.

In certain embodiments, the chitosan encapsulates the polymeric core.

In certain embodiments, the microparticle has been treated with a base (e.g., a hydroxide base). In certain embodiments, the microparticle has been treated with 1 M sodium hydroxide.

In certain embodiments, the microparticle further comprises an active agent (e.g., a biologically active agent, such as a drug).

In another aspect, the present disclosure provides methods of making the microparticles disclosed herein, comprising the steps of:
i) contacting a mold with a solution comprising a solvent, a plurality of polymeric beads, and chitosan;
ii) evaporating the solvent, thereby forming a polymeric bead-chitosan micro pattern;
iii) contacting the polymeric bead-chitosan micro pattern with a base; and
iv) neutralizing the base.

In certain embodiments, the method further comprises comprising contacting the microparticle with an active agent (e.g., a biologically active agent, such as a drug).

In certain embodiments, the base is aqueous sodium hydroxide (e.g., 1 M aqueous sodium hydroxide).

In certain embodiments, the micro pattern is circular, square, hexagonal, or triangular.

In certain embodiments, the method is performed at a humidity greater than about 80%, about 85%, about 90%, or about 95%. In certain embodiments, the method is performed at a humidity greater than about 90%. In certain embodiments, the method is performed at a humidity greater than about 93%.

In certain embodiments, step iii) further comprises contacting the polymeric bead-chitosan micro pattern with an aqueous solution of polysorbate 20 (i.e., Tween® (TW)) (e.g., 0.05% v/v polysorbate 20) subsequent to contacting the polymeric bead-chitosan micro pattern with the base.

In certain embodiments, the polymeric bead-chitosan micro pattern is contacted with the solution of aqueous solution of polysorbate 20 at least three times (e.g., 3 times).

### Definitions

Unless otherwise defined herein, scientific and technical terms used in this application shall have the meanings that are commonly understood by those of ordinary skill in the art. Generally, nomenclature used in connection with, and techniques of, chemistry, cell and tissue culture, molecular biology, cell and cancer biology, neurobiology, neurochemistry, virology, immunology, microbiology, pharmacology, genetics and protein and nucleic acid chemistry, described herein, are those well known and commonly used in the art.

The methods and techniques of the present disclosure are generally performed, unless otherwise indicated, according to conventional methods well known in the art and as described in various general and more specific references that are cited and discussed throughout this specification. See, e.g. “Principles of Neural Science”, McGraw-Hill Medical, New York, N.Y. (2000); Motulsky, “Intuitive Biostatistics”, Oxford University Press, Inc. (1995); Lodish et al., “Molecular Cell Biology, 4th ed.”, W. H. Freeman & Co., New York (2000); Griffiths et al., “Introduction to Genetic Analysis, 7th ed.”, W. H. Freeman & Co., N.Y. (1999); and Gilbert et al., “Developmental Biology, 6th ed.”, Sinauer Associates, Inc., Sunderland, MA (2000).

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

The term “agent” is used herein to denote a chemical compound (such as an organic or inorganic compound, a mixture of chemical compounds), a biological macromolecule (such as a nucleic acid, an antibody, including parts thereof as well as humanized, chimeric and human antibodies and monoclonal antibodies, a protein or portion thereof, e.g., a peptide, a lipid, a carbohydrate), or an extract made from biological materials such as bacteria, plants, fungi, or animal (particularly mammalian) cells or tissues. Agents include, for example, agents whose structure is known, and those whose structure is not known.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

### EXAMPLES

The invention now being generally described, it will be more readily understood by reference to the following examples which are included merely for purposes of illustration of certain aspects and embodiments of the present invention and are not intended to limit the invention.

### Example 1: Preparation of Exemplary Microparticles

Polymeric opal microparticles are an important class of emerging engineering materials, and have shown a significant potential in a variety of applications ranging from anticounterfeit labels and sensors to drug delivery systems. Despite several existing techniques, there is a critical need for a simple, reliable and robust fabrication method of responsive opal microparticles. We report a simple soft-lithographic micromolding technique utilizing evaporative deposition and neutralization to manufacture uniform and tunable opal microparticles containing potent aminopolysaccharide chitosan (CS). CS plays a crucial role in the formation of stable opal structures and polymer networks, as well as chemical reactivity and stimuli-responsive properties that enable multiple functionalities and controlled electroassembly in a spatially selective manner. Finally, uniform and stable CS-inverse opal microparticles were successfully prepared by simple exposure to toluene. We envision that our facile evaporation-neutralization technique harnessing unique properties of CS can be readily extended to develop various engineering materials for a wide range of applications.

Materials. Medium molecular weight CS (ave. MW 190-300 kDa), polyvinylpyrrolidone (PVP) (ave. MW 40 kDa), Potassium persulfate (KPS, initiator, 99.99%), styrene (Reagent Plus, ≥99% purity), saline sodium citrate buffer (SSC) 20× concentrate, glutaraldehyde (Grade I, 25% in deionized (DI) water), sodium borohydride (powder, ≥98% purity), isopropyl alcohol (IPA) (99.5% purity), and toluene (anhydrous, ≥99.8% purity) were purchased from Sigma-Aldrich (St. Louis, MS). Aqueous solution of polysorbate 20 (TW 20) and ethylene glycol (EG) (99%, Acros Organics), 12.1 N hydrochloric acid (HCl), 1 N sodium hydroxide (NaOH) solution, and sodium hypochlorite solution (4-6% v/v) were purchased from Thermo Fisher Scientific (Waltham, MA). Poly(dimethylsiloxane) (PDMS) elastomer kits (Sylgard 184) were supplied by Dow Corning (Auburn, MI). Carboxyfluorescein succinimidyl ester (NHS-fluorescein) was purchased from Pierce Biotechnology (Rockford, IL).

Synthesis of PS Beads. PS beads were synthesized using a similar procedure as listed in our previous reports via emulsion polymerization technique. Briefly, to prepare PS beads with varied diameters, the PVP content was varied from 0.2-0.6 g and dissolved in 90-100 mL DI water in a 250 mL round bottom flask. Then, 11 mL of styrene monomer was added to the PVP solution and stirred for 15 min at room temperature. Freshly prepared initiator solution containing 0.15 g of KPS in 10 mL of DI water was then added into the mixture, which was then stirred at 72° C. for 24 h. Upon completion of this emulsion polymerization reaction, the mixture was centrifuged and washed with DI water three times to remove the unreacted monomers. Finally, the resulting PS beads were sonicated using an ultrasonic dismembrator (Branson Ultrasonics, Danbury, CT) to obtain monodisperse PS beads.

Preparation of micropatterned PDMS molds. The PDMS molds containing micropatterns with different shapes (circle, triangle, square, and hexagon) were prepared using a similar procedure as listed in our previous reports using a silicone mastermold having micropatterns with different shapes prepared via photolithography. The resulting PDMS mold contains 0.7×0.7 cm² area having 1600 of 40 μm deep micropatterns with different shapes.

Preparation of CS solution. First, 10 g of the medium molecular weight CS powder was added to 700 mL of DI water and mixed via magnetic stirring at 90° C. on a stirring hot plate. While mixing, 1 N HCl was added every 2 h until the pH reached 3, upon which DI water was added to prepare 1 L of the 1% w/v CS solution. The resulting 1% w/v CS solution was mixed at 90° C. until the CS completely dissolved, upon which the solution was filtered through 0.45 μm membrane filters (asymmetric polyethersulfone (aPES) membrane, Thermo Fisher, Pittsburgh, PA, USA). The filtered 1% w/v CS solution was then used for all the studies in this report.

Evaporative deposition of PS beads for preparation of CS-opal micropatterns. A 100 μL aqueous solution containing 35.5% w/v PS beads, 0.12% w/v CS, 2.5% v/v TW 20, and 0.1% v/v EG was added onto the PDMS molds having micropatterns with different shapes. Then, inside a humidity chamber (relative humidity >93%), the microwells were filled with the PS bead solution by rubbing with a pipette tip after which the excess PS bead solution on the PDMS mold was removed via pipetting. Upon filling the microwells, the DI water was allowed to evaporate in the humidity chamber (relative humidity >93%) for 1.5 h to allow controlled assembly of PS beads to form the CS-opal micropatterns.

Neutralization and recovery of CS-opal microparticles. About 200 μL of IN NaOH solution was added on top of the CS-opal micropatterns in a PDMS mold for 7 min then removed by pipetting. 50 μL 5×SSC buffer (pH 7) was then added on top of the CS-opal micropatterns to recover the CS-opal microparticles. The microparticles were then washed three times with a 0.05% v/v TW 20 solution and stored in a microcentrifuge tube.

Stability of CS-opal microparticles in extreme conditions. Individual batches of CS-opal microparticles were incubated in 0.7 N HCl (pH 0.1) solution, 1 N NaOH (pH 13.1) solution, 99% v/v IPA and at 100° C. for 15 h respectively. For incubation in extreme pH conditions, 0.05% v/v TW 20 solution was exchanged three times with the 0.7 N HCl (pH 0.1) or IN NaOH (pH 13.1), then the CS-opal microparticles were incubated in the solutions for 15 h on a nutating mixer. Similarly, for incubation of the CS-opal microparticles in IPA, the 0.05% v/v TW 20 solution in which the microparticles were suspended in was exchanged with IPA three times then incubated in IPA for 15 h on a nutating mixer. To examine the stability of the CS-opal microparticles at 100° C., the CS-opal microparticles were placed in 5 mL glass tubes and placed on a hot stirring plate (Chemglass Optichem, Vineland, NJ, USA) with the solution temperature controlled at 100° C. using a thermal probe for 15 h. Following the incubation, the microparticles were washed with the 0.05% v/v TW 20 solution three times and imaged via darkfield optical microscopy.

Preparation of CS-opal microparticles with varied CS content. First, opal micropatterns were prepared via evaporative deposition with or without varied CS content ranging from 0 to 0.24% w/v CS while maintaining the fixed concentrations of PS beads, TW 20, and EG. Next, the micropatterns were neutralized using a 1 N NaOH solution and recovered using 5×SSC buffer (pH 7). The retrieved microparticles were washed three times with 0.05% v/v TW 20 and stored in microcentrifuge tubes before being imaged via darkfield optical microscopy.

Fluorescent labelling of CS-opal microparticles using NHS-fluorescein. The opal and CS-opal microparticles prepared using 0 to 0.24% w/v CS content were washed five times with a 5×SSC buffer (pH 7) having 0.05% v/v TW 20. The microparticles were then incubated on a nutating mixer with 20 μM NHS-fluorescein at room temperature for 1 h after which the microparticles were washed three times with aqueous 50% v/v IPA solution and four times with 5×SSC buffer (pH 7). Finally, the fluorescently labelled microparticles were imaged via epifluorescence and darkfield optical microscopy.

Preparation and treatment of patterned chips for electroassembly. The chips used for electroassembly experiments consist of a silicon wafer having two gold rectangular patterns (1 mm×8 mm) that are separated by 1 mm and are each linked through an 8 mm long gold line to rectangular gold patterns having 3 mm×4 mm dimensions used for connecting alligator clips. The chips were prepared as listed in our previous reports. A top photoresist layer was removed by incubating the chips in a IN NaOH solution for 1 h followed by incubation in a 2% v/v sodium hypochlorite solution for 15 min. Finally, the chips were profusely washed with DI water.

Electroassembly of CS-opal microparticles onto electrodes. CS-opal microparticles were washed with 0.1 M sodium acetate buffer (pH 4.1) twice and incubated in the sodium acetate buffer overnight. Then, about 35 μL of CS-opal microparticles in the sodium acetate buffer was added via pipetting to cover the patterned gold electrode surfaces on the chip connected to a Keithley 2602A system source meter (Keithley Instruments, Solon, OH, USA) using alligator clips. Then, the electroassembly was performed at 5 A/m² current for 10 min. Upon completion of the electroassembly process, the chip was gently rinsed with DI water and imaged using a cell phone camera and darkfield optical microscopy. Results from at least triplicate experiments per CS content condition were obtained for reproducibility.

Preparation of CS-inverse opal (CS-IO) microparticles. First, CS-opal microparticles were incubated with 0.1% w/v glutaraldehyde in 5×SSC buffer (pH 7) having 0.05% v/v TW 20 on a nutating mixer for 5 min. The CS-opal microparticles were then washed twice with 5×SSC buffer with 0.05% v/v TW 20. Meanwhile, a sodium borohydride solution was freshly prepared by adding a small chunk of sodium borohydride powder in 5×SSC buffer having 0.05% v/v TW 20. Immediately after the chunk of sodium borohydride was dissolved and started bubbling, 75 μL of the solution was added to the vial having glutaraldehyde reacted CS-opal microparticles. After the bubbles stopped forming, the CS-opal microparticles were centrifuged at 13,200 g for 5 min and washed twice with 0.05% v/v TW 20 solution. The microparticles were then dried in an oven at 70° C. for 2 h. Then, the microparticles were incubated in toluene having 2% v/v TW 20 for 48 h on a nutating mixer. Upon the 48 h incubation, the solvent was exchanged with toluene having 2% v/v TW 20 twice to wash away the dissolved PS. Finally, the resulting CS-IO microparticles were then washed three times with IPA and twice with 0.05% v/v TW 20 solution and imaged using darkfield optical microscopy.

Diffraction Peak Wavelength Measurement. To measure the absorbance spectra, the PDMS mold containing CS-opal micropatterns or an aqueous solution containing CS-opal microparticles or CS-IO microparticles was added into a single well in a 96-well plate (Corning© Costar, tissue culture treated clear polystyrene 96-well plate, Milwaukee, WI). Absorbance spectra (wavelength range: 300-750 nm, 10 nm interval) were recorded using a SpectraMax i3X plate reader (Molecular Devices, LLC., San Jose, CA).

Dynamic Light Scattering. The size of various PS beads was measured using dynamic light scattering (DLS, ZetaPALS particle analyzer, Brookhaven, NY) equipped with a 10 mW He—Ne laser at 630 nm.

### Imaging and Analysis of CS-Opal Microparticles

Optical microscopy. The epifluorescence and darkfield optical micrographs of the CS-opal and -IO microparticles were obtained using an Olympus BX51 microscope (Olympus Corp., Center Valley, Pennsylvania) equipped with a DP70 microscope digital camera. The epifluorescence micrographs of the fluorescently labelled microparticles were obtained with a 10× objective lens under a standard green (U-N31001) filter set (Chroma Technology Corp., Rockingham, VT, USA).

Optical Profilometry. The top and titled view optical micrographs and surface profiles of partially dried CS-opal microparticles were obtained using a Zeta-20 Optical Profilometer (ZETA Instruments, San Jose, California, USA).

Scanning electron microscopy (SEM). To obtain the SEM images, the CS-opal and -IO microparticles were dried for 1.5 h at room temperature. Upon drying, using a Cressington 108 Sputter Coater (Cressington Scientific Instruments, Watford, UK), the CS-opal and -IO microparticles were sputter-coated with a gold-palladium alloy for 60 s and 30 s respectively at 30 mA under an argon atmosphere. Finally, the coated CS-opal and -IO microparticles were imaged at 5 kV using a Zeiss EVO MA10 SEM (Carl Zeiss Pvt. Ltd., Oberkochen, Germany).

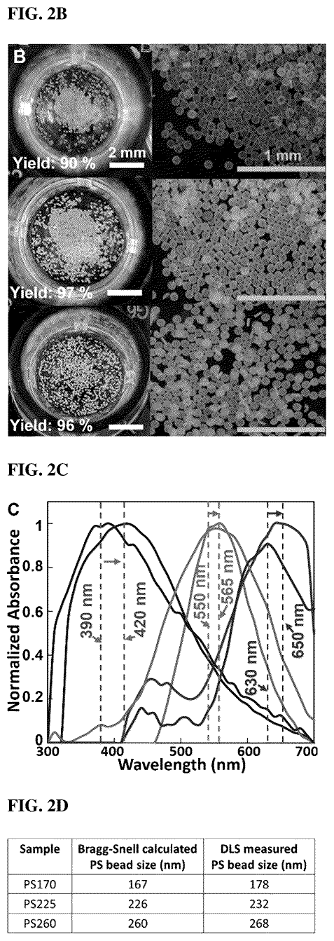

In FIGS. 2A-2D, we demonstrate robust and reliable fabrication of chitosan (CS)-opal micropatterns and microparticles via our simple evaporative deposition-neutralization method. For this, we first added an aqueous solution containing PS beads of varied sizes and CS onto micropatterned PDMS molds and allowed slow evaporation of water to form CS-opal micropatterns as shown in the schematic diagram of FIG. 1A. Next, we added IN NaOH to neutralize the CS and retrieved the CS-opal microparticles. Photographs and absorbance spectra of the CS-opal micropatterns and the microparticles were obtained using a cellular phone camera and a 96-well plate reader using absorbance mode respectively. The sizes of the PS beads were calculated using the Bragg-Snell equation and measured via dynamic light scattering (DLS) as well.

First, the photograph on the left side of the top row in FIG. 2A shows a PDMS mold containing circle-shaped CS-opal micropatterns prepared using PS170 beads with uniform blue color, indicating reliable and high yield (1590 out of 1600, 99%) fabrication. Next, the darkfield optical micrograph on the right side of the top row in FIG. 2A shows six circular CS-opal micropatterns (PS170) with uniform blue color among and within micropatterns, further confirming reliable and robust fabrication of uniformly colored CS-opal micropatterns using our simple evaporative deposition technique (referred to as evaporation).

Similarly, the photographs and micrographs of CS-opal micropatterns in the PDMS mold prepared using PS225 and PS260 beads in the middle and bottom rows of FIG. 2A having high yields (98 and 99%) equivalent to those with PS170 show uniform green and orangish-red colors respectively, illustrating robust and reliable preparation of uniform CS-opal micropatterns via simple evaporation.

Next, the photograph on the left side of the top row in FIG. 2B shows CS-opal microparticles prepared with PS170 in a well of a 96-well plate with blue color and high fidelity (1440 out of 1600 possible microparticles, 90% yield) upon exposure to IN NaOH followed by recovery in aqueous solution via pipetting. The darkfield optical micrograph on the right side of the top row in FIG. 2B shows a representative set of CS-opal microparticles with uniform blue color among and throughout each microparticle. These results indicate simple and high-yield preparation of uniform CS-opal microparticles via our evaporation-neutralization method.

Similarly, the photographs and micrographs of the CS-opal microparticles prepared with PS225 and PS260 in the middle and bottom rows of FIG. 2B respectively show high fidelity (97 and 96%), and uniform green and orangish-red colors, again illustrating the reliable and robust nature of our simple evaporation-neutralization method.

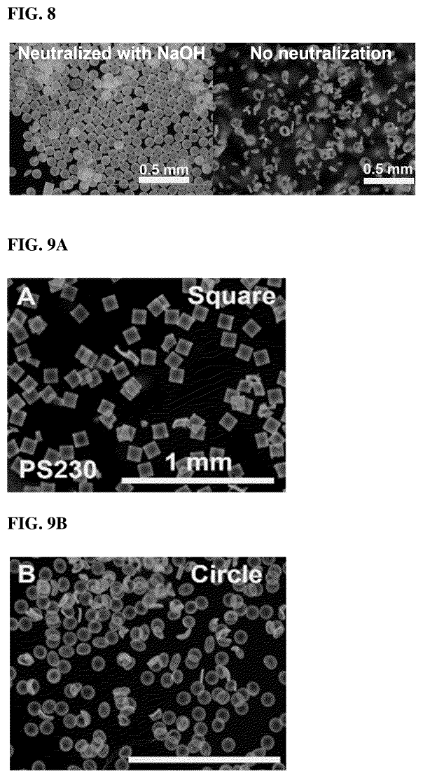

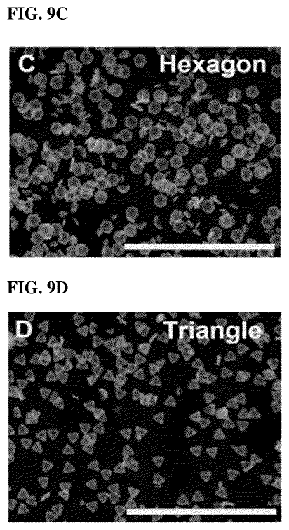

Meanwhile, microparticles that were not exposed to NaOH appeared broken and fragile (FIG. 8), confirming the utility of the neutralization step and CS's pH-responsive property in the reliable and high-yield production of CS-opal microparticles. The pKa of CS's primary amine groups is around 6.4, making CS soluble in low pH conditions due to electrostatic repulsion among the positively charged amines. Upon sudden exposure to high pH (i.e., 1N NaOH, pH 13.1), the amines become neutral allowing the formation of stable polymer networks capturing the opal structures formed via controlled assembly of PS beads by evaporation. In addition, CS in the aqueous PS bead solution is thought to form strong bonding with PS beads via electrostatic attraction with negatively charged PS bead surfaces (from potassium persulfate initiator for the PS bead synthesis), providing stability to the opal structures as further evidenced via zeta potential measurements (Table S1) consistent with our recent study.³⁷ Further, CS-opal microparticles prepared with varied 2D shapes (circle, square, hexagon, and triangle) exhibited consistently uniform color and high yield (FIGS. 9A-9D), indicating the robustness in addition to other advantages of the simple micromolding method in creating simple shape encoding schemes for various applications (e.g., anti-counterfeiting and multiplexed sensing).

We then recorded the spectra of the CS-opal micropatterns and the microparticles prepared with the three different PS bead sizes using absorbance mode in a 96-well plate reader as shown in FIG. 2C. Uniform diffraction by our opal structures enabled recording of the diffraction spectra in a standard absorbance mode. First, the peak wavelengths from PS170-, PS225- and PS260-based CS-opal micropatterns are 390 nm, 550 nm and 630 nm respectively as shown in FIG. 2C, corresponding to the blue, green and orangish-red colors. These colors correlate well with the colors captured in the photographs and the micrographs in FIG. 2A, illustrating the suitability of the spectral measurements in the absorbance mode. These measured diffraction peak wavelengths were then utilized to calculate the PS bead sizes using Bragg-Snell equation (Table S2) and compared with the PS sizes measured via DLS as shown in the table of FIG. 2D. The sizes of the PS beads measured via DLS correlated well with those calculated using Bragg-Snell equation with a maximum and minimum difference of 11 nm and 6 nm respectively, demonstrating the validity of utilizing Bragg-Snell equation to estimate the PS bead size. Note, DLS measurements tend to overestimate the PS bead size due to the hydration shell on the surface of the PS beads;^{37, 42} we thus use the calculated sizes based on the Bragg-Snell equation to denote the PS bead sizes throughout this study.

Next, the measured diffraction peak wavelengths of PS170-, PS225- and PS260-based CS-opal microparticles in FIG. 2C are 420 nm, 565 nm and 650 nm respectively corresponding to blue, green and orangish-red, also matching with the colors in the photographs and the micrographs in FIG. 2B. The peak wavelength shift (A) max) of 30 nm for PS170-, 15 nm for PS225-, and 20 nm for PS260-based microparticles compared to those of the micropatterns is likely due to the change in the refractive index (n) of the surrounding media and the change in the interplanar distance caused by slight swelling of microparticles, stemming from hydration of CS-opal microparticles. The change in the refractive index of the surrounding media from air (nₐᵢᵣ=1.0059) for the micropatterns vs. water (n_{water}=1.33) for the microparticles causes about 20 nm peak wavelength shift as shown by calculations using Bragg-Snell equation in Table S2. The measured diameters of CS-opal micropatterns and microparticles obtained from the darkfield micrographs in FIGS. 2A & B are 99 μm and about 102 μm respectively. This increased diameter of up to 3 μm for the microparticles compared to the micropatterns leads to about 3.5 nm increase in the interplanar distance between the PS beads, causing up to 10 nm peak wavelength shift as shown by the Bragg-Snell equation calculations in Table S2. Combining these refractive index and interplanar distance changes lead to the 20 to 30 nm shift in peak wavelength from those of the micropatterns compared to those of the microparticles as calculated using Bragg-Snell equation in Table S2, which correlates well with those of the experimentally measured peak wavelengths in FIG. 2C.

In sum, the results in FIG. 2 show the robust and reliable nature of our simple evaporation-neutralization method for the production of uniform and tunable CS-opal micropatterns and CS-opal microparticles, as well as the utility of the Bragg-Snell equation to estimate the PS bead sizes that correlate well with the experimentally measured values acquired by DLS.

### Morphology and Surface Profile of CS-Opal Microparticles

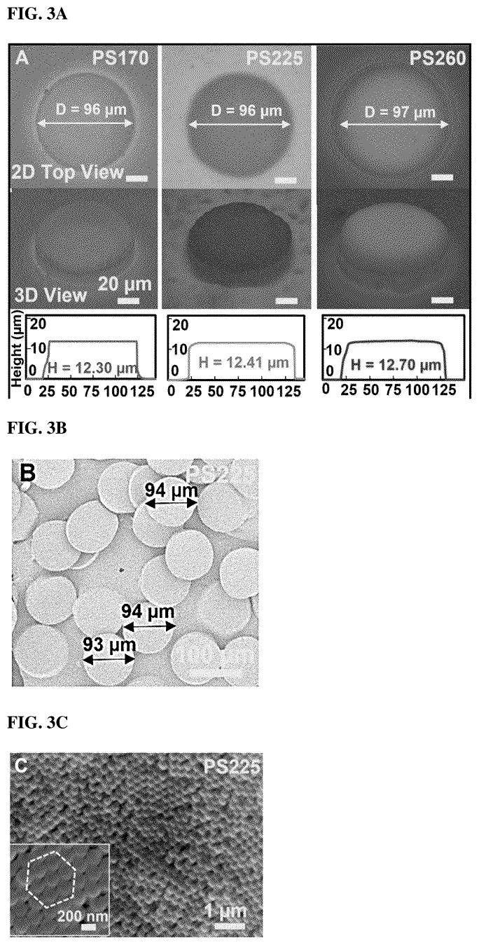

We next examined the morphological features of the as-prepared CS-opal microparticles via optical profilometry and scanning electron microscopy (SEM) as shown in FIG. 3.

First, the optical micrographs showing the top (top row) and 3-D (mid row) views of three microparticles fabricated with PS170, PS225 and PS260 respectively in a partially dry state using identical PDMS micromolds in FIG. 3A show well-defined dimensions (diameter ˜96 μm). Note, these micrographs were acquired using the optical microscope of the optical profilometer not designed for recording colors yet show the corresponding colors indicating the uniform diffraction of light through well-ordered opal structures. The height profiles of the three microparticles at the bottom row of FIG. 3A clearly show uniform heights (˜12.5 μm) within and among microparticles prepared with different PS bead sizes, illustrating the robust and reliable nature of our simple evaporation-neutralization method.

Next, SEM images of dried microparticles prepared with PS225 in FIG. 3B also show uniform dimensions (diameter ˜94 μm) and well-preserved shapes of microparticles, while the zoomed-in cross-sectional view in FIG. 3C clearly shows close hexagonal packing (face centered cubic, FCC) of the PS beads in the interior of a CS-opal microparticle, indicating efficient assembly via evaporative deposition and stability via neutralization. Note, the diameters of the microparticles change from approximately 96 μm in a partially dried state in the optical profilometry measurements to 94 μm in a completely dried state in SEM, showing slight shrinkage of the CS-opal microparticles as expected.

In short summary, the optical profilometry and SEM results in FIG. 3 demonstrate the uniform dimensions, efficient PS bead assembly, and robustness of our simple fabrication method.

Stability of CS-opal microparticles in extreme conditions

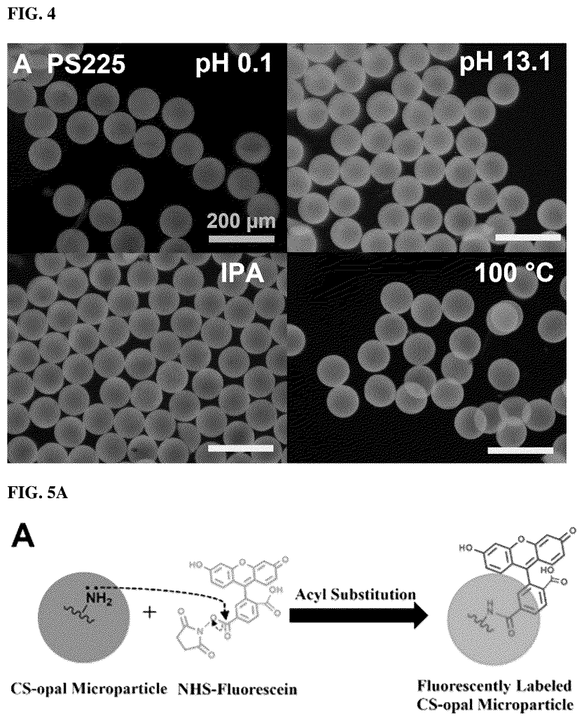

Next, we examined the stability of the as-prepared CS-opal microparticles in several extreme conditions as shown in FIG. 4. For this, CS-opal microparticles prepared with PS225 were separately exposed to 0.7 N HCl (pH 0.1), 1 N NaOH (pH 13.1), isopropanol (IPA), and 100° C. respectively then imaged via darkfield optical microscopy.

The micrographs in FIG. 4 show that the microparticles exposed to various extreme conditions all maintained their dimensions and opalescent color (peak wavelength λₘₐₓ˜565 nm), clearly indicating robustness and stability. We attribute this to the stable nature of the polymer networks formed upon neutralization of the amine groups on CS.

### Chemical Functionality of CS-Opal Microparticles

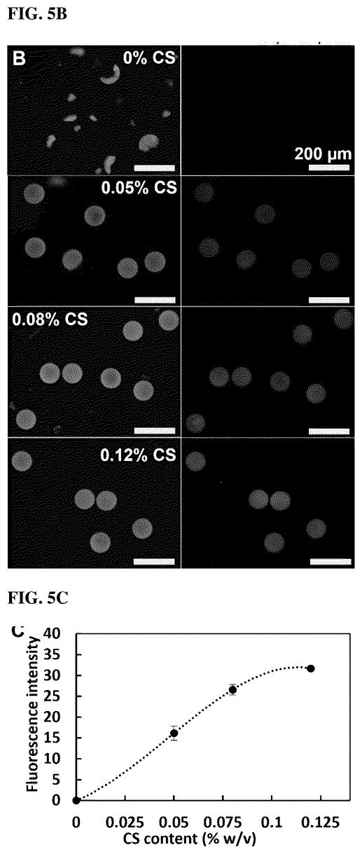

We next demonstrate chemical functionality of the CS-opal microparticles via simple fluorescent labeling, as shown in FIG. 5. For this, we exposed CS-opal microparticles prepared with PS260 and varied CS content (0 to 0.12% w/v) to an amine-reactive form of fluorescein (carboxyfluorescein-NHS ester, NHS-fluorescein), as shown in the schematic diagram of FIG. 5A. CS's primary amine groups with unusually low pKa (˜6.4) possess highly nucleophilic pair of unshared electrons in the neutral state that form stable amide linkages with electron-deficient carbons via acyl substitution reaction.

First, the darkfield micrograph of CS-opal microparticles prepared without CS at the left top of FIG. 5B show broken and brittle microparticles without CS (top), consistent with the results in FIG. 8 and again demonstrating the critical role of CS in providing sufficient binding strength and mechanical integrity to hold the opal structure together. Next, micrographs in the second to fourth rows on the left column of FIG. 5B show uniform opalescence throughout and among each microparticle with negligible difference in dimensions or peak wavelengths (λₘₐₓ˜650 nm) across all CS contents consistent with the results in FIG. 2, indicating minimal swelling or change with varied CS content and the robustness of the fabrication method itself.

The epifluorescence micrographs of these microparticles upon reaction with amine-reactive NHS-fluorescein on the right column of FIG. 5B show uniform green fluorescence among and within each CS-opal microparticle confirming the chemical functionality and accessibility of the amine groups to amine-reactive chemistries with small molecules (i.e. NHS-fluorescein), while the microparticles prepared without CS showed minimal fluorescence. Higher CS content led to brighter fluorescence, showing the ready tunability in amine functional titer on the microparticles by simply varying the CS content in the aqueous PS bead solutions used for the deposition. This trend in fluorescence is then quantified using ImageJ software and plotted as shown in FIG. 5C. Briefly, the average fluorescence intensity linearly increased with CS content and then plateaued at 0.12 w/v % CS, illustrating the ready tunability of functionalization via simple and efficient amine-reactive chemistries rising from the highly nucleophilic amine moieties of CS.

Combined, the opalescence and the fluorescence results in FIG. 5 illustrate that one can impart dual optical characteristics by exploiting CS that offers binding affinity to form stable opal microparticles as well as tunable chemical reactivity for further functionalization.

### Spatially Selective Electroassembly of the CS-Opal Microparticles

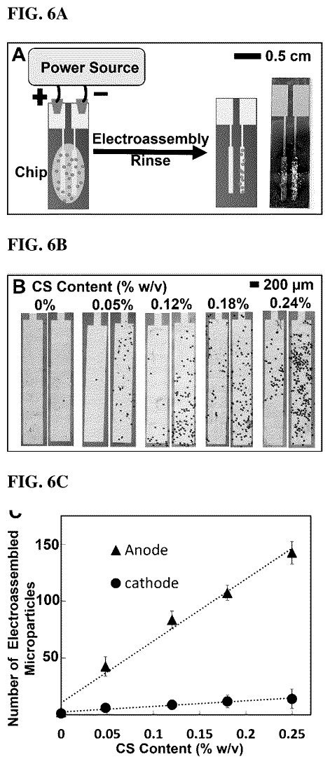

In addition to the chemical functionality, the low pKa value and pH-responsive property of CS can also be harnessed to direct controlled assembly in response to electric signals. In FIG. 6, we demonstrate spatially selective and programmable electroassembly of CS-opal microparticles onto patterned electrodes. For this, aqueous solutions containing CS-opal microparticles prepared with PS225 with varying CS content in sodium acetate buffer (0.1 M, pH 4) were added onto chips with photolithographically patterned gold electrodes as shown in the schematic diagram of FIG. 6A. Upon applying 5 A/m² for 10 min, the chips were gently rinsed with DI water and the numbers of particles assembled on each patterned electrode area were counted from darkfield micrographs as in FIG. 6B. Most of CS's primary amines are positively charged at pH 4 as confirmed via zeta potential measurements in Table S1, thus attracted to then assemble on the negatively charged areas (i.e., anodes) where local high pH gradient develops by influx of electrons.

First, the leftmost darkfield micrographs in FIG. 6B show minimal number of microparticles prepared without CS in either the cathode (left) or the anode (right), indicating negligible electroassembly due to the absence of CS. Next, micrographs of the electrodes with increasing CS content (0.05 to 0.24% w/v) from left to right in FIG. 6B show a small number of particles on the cathode (left) and an increasing number on the anode (right), clearly indicating a positive correlation between the CS content and the number of microparticles assembled. This trend is further quantified in the plot of FIG. 6C, where the number of microparticles assembled on the anode (solid triangles) shows a linear increase to the CS content. Meanwhile, the number of the microparticles on the cathode (solid circles) in FIG. 6C as well as on the un-patterned areas (data not shown) were substantially lower, clearly illustrating the spatially selective electroassembly of CS-opal microparticles rising from the pH-responsive property of CS. Interfacing electronics and biologics in a spatially controlled and programmable manner to prepare bio-electronic devices for anticounterfeiting and biosensing applications continues attracting attention yet remains challenging. The opal microparticle electroassembly results in FIG. 6 utilizing the pH responsiveness of CS thus directly addresses these challenges.

In short, the spatially selective and programmable electroassembly results in FIG. 6 illustrate controlled assembly of pH-responsive CS-opal microparticles in response to electrical signal.

### Preparation of Stable and Uniform CS-Inverse Opal Microparticles

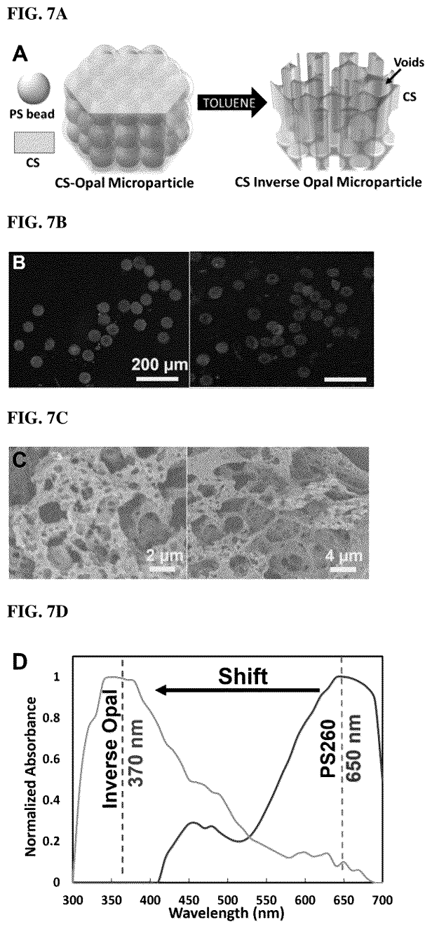

Dissolution of lattice forming materials in opal structures allows the preparation of macroporous inverse opal (IO) materials that can be used in a wide range of applications including the preparation of membranes, 3-D scaffolds for cell cultivation, and capsules for controlled drug release. Despite such substantial potential and recent attention, IO materials are usually prepared via complex multi-step processing and suffer from compromised mechanical strength and/or non-uniform opalescence stemming from weak hollow structures formed upon dissolution of rigid nanospheres. We thus examined the preparation of uniform IO microparticles via a simple PS dissolution process upon exposure to toluene as shown in FIGS. 7A-7D. For this, CS-opal microparticles were lightly crosslinked using a homobifunctional crosslinker glutalaldehyde, then exposed to toluene for 48 h as shown in the schematic diagram of FIG. 7A. The as-prepared CS-IO microparticles were then imaged via darkfield optical microscopy upon rinsing with 2-isopropanol (IPA) and 0.05% TW 20 solutions, as well as the spectra measured using the well plate reader as in FIG. 2A-2D.

The darkfield micrographs of FIG. 7B show multiple uniform bluish-green colored CS-IO microparticles prepared from PS260-based CS-opal microparticles, illustrating successful preparation using our simple procedure. The CS-IO microparticles in FIG. 7B have a uniform diameter of 69 μm in comparison to that of the PS260 based CS-opal microparticles having 101 μm diameter as in FIG. 2B. The shrinkage of the microparticles is likely due to the dissolution of the PS beads leading to the formation of “soft” orderly packed lattice of pores in the CS-IO microparticles compared to the fixed lattice structures in CS-opal microparticles composed primarily of PS beads. This result illustrates the formation of uniformly ordered porous microparticles enabling opalescence despite having minimal CS content (0.12% w/v) in the aqueous PS bead solution. Further, this result shows the utility of the neutralization step to form CS-IO microparticles with sufficient mechanical strength using a simple crosslinking treatment even upon long exposure to organic solvent (i.e., toluene) and extensive rinsing steps. Next, the SEM images of the CS-IO microparticles in dry state in FIG. 7C show formation of porous structures consistent with other studies, despite apparent collapse of the structure due to high vacuum and intense electron beam through the SEM imaging procedure. Yet despite the non-uniform pore structure shown in FIG. 7C, the uniform opalescent color of the CS-IO microparticles in the wet state in FIG. 7B clearly shows strong evidence of highly ordered pores throughout and among each microparticle.

Finally, the diffraction peak wavelengths (λₘₐₓ) of the CS-opal and CS-IO microparticles were measured to be 650 nm and 370 nm respectively as shown in FIG. 7D with a large wavelength shift (A) \max) of −280 nm. We attribute this large shift to the combination of the interplanar distance and the refractive index changes both stemming from dissolution of PS beads in CS-opal microparticles (Table S3). Again, we utilized the Bragg-Snell equation to estimate individual and collective contributions of the two factors leading to this observed peak wavelength shift as shown in Table S3. The refractive index changes upon dissolution of PS beads (n_{PS}=1.59) from the CS-opal microparticles leads to water-filled pores (n_{water}=1.33) in the CS-IO microparticles yielding wavelength shift of −81 nm. Meanwhile, the interplanar distance change from 260 nm in CS-opal microparticles to 177 nm in CS-IO microparticles caused by the observed reduction in the microparticle diameter (from 101 to 70 μm) upon dissolution of PS beads leads to a large wavelength shift of −202 nm (Table S3). In combination, these changes in the interplanar distance and the refractive index result in-283 nm. This calculated peak wavelength shift closely correlates with the experimentally measured peak wavelength shift of −280 nm shown in FIG. 7D, confirming the effect of both factors causing the wavelength shifts along with the utility of Bragg-Snell equation-based estimation.

In short, FIG. 7 shows successful preparation of stable and uniform CS-IO microparticles having minimal CS content with good mechanical integrity in retaining highly ordered packing structures.

### SUMMARY

In this report, we demonstrated controlled fabrication of uniform, stable and responsive CS-opal microparticles via a reliable and tunable evaporation-neutralization technique based on simple micromolding. First, uniform and tunable CS-opal micropatterns were prepared via simple evaporation. Uniform, stable and responsive CS-opal microparticles were then prepared with high yield and fidelity simply by exposing the CS-opal micropatterns to IN NaOH that neutralizes the primary amine groups of CS allowing the formation of stable CS polymer networks. Optical profilometry and SEM results confirmed close hexagonal packing of PS beads in CS-opal microparticles formed upon evaporative deposition that were well preserved through neutralization, as well as the consistent surface profiles of the microparticles. The as-prepared CS-opal microparticles showed not only stability and robustness upon exposure to various extreme conditions, but also chemical functionality and responsiveness to stimuli enabling fluorescent labeling and spatially controlled electroassembly respectively. Exposure of the CS-opal microparticles to toluene allowed the preparation of uniform and stable CS-IO microparticles, confirming the mechanical robustness of the CS scaffolds.

Combined, these results illustrate two innovative aspects of our approach. First, the soft-lithographic micromolding fabrication method allows simple and reliable manufacturing of highly tunable microparticles with various 2D shapes. Second, the unique and potent properties of an abundant and biologically derived polysaccharide CS can be exploited in multiple ways to prepare multifaceted microparticles. The key benefits of CS demonstrated in this report include: (1) the abundant positive charge allowing electrostatic attraction between the CS and PS leading to reliable capture of the opal structures, (2) pH-responsive morphology shift yielding stable polymeric networks upon simple neutralization with NaOH as well as spatially selective electroassembly, and finally (3) chemical functionality rising from the highly nucleophilic nature of the amines in the neutral state. We thus believe that harnessing the unique properties of biological materials such as CS can lead to facile production of novel engineering materials, and envision that our approach can be utilized to produce multifaceted and responsive materials for a variety of biomedical and sensing applications.

### ADDITIONAL INFORMATION

Effect of neutralization with NaOH on preparation of CS-opal microparticles, zeta potential measurements of CS-opal microparticles in different pH conditions, CS-opal microparticles with various shapes, effect of refractive index and interplanar distance changes on the peak wavelength shifts from CS-opal micropatterns to CS-opal microparticles, and effect of refractive index and interplanar distance changes on the peak wavelength shifts from CS-opal microparticles to CS-inverse opal (IO) microparticles.

Effect of Neutralization with 1N NaOH on the Preparation of CS-Opal Microparticles

In FIG. 8, we demonstrate the neutralization with IN NaOH on the preparation of CS-opal microparticles.

For this, CS-opal micropatterns were first prepared via evaporative deposition using PS225 in two separate micropatterned PDMS molds. Then, CS-opal micropatterns in one of the PDMS molds was exposed to IN NaOH for neutralization while the other was not exposed to NaOH. Upon the neutralization step, CS-opal microparticles were retrieved from the PDMS molds using 5×SSC buffer (pH 7) and imaged using darkfield optical microscopy as shown in FIG. 8.

The darkfield micrographs on the left and right side of FIG. 8 show CS-opal microparticles prepared with and without neutralization with NaOH respectively. The darkfield micrograph on the left side of FIG. 8 shows high yield formation of uniform green-colored CS-opal microparticles as a result of neutralization with IN NaOH, while the darkfield micrograph on the right side shows brittle and broken microparticles as a result of no neutralization with NaOH clearly showing the need for neutralization to prepare stable CS-opal microparticles. Neutralization of amine groups on CS allows the formation of stable polymer networks¹⁻² that capture orderly packed lattices (face centered cubic, FCC) of PS beads (i.e., opal structures) formed upon evaporative deposition.

In short, FIG. 8 clearly demonstrates the utility of neutralization using 1N NaOH to prepare uniform CS-opal microparticles in high yield.

### 2. Zeta Potential Measurements of CS-Opal Microparticles in Different pH Conditions

TABLE S1
Measured zeta potential of CS-opal microparticles at pH 4.1 and
6.7 compared to that of the CS-opal microparticles prepared via
degradation of gelatin films as reported in our previous study.

| | Zeta |
|---|---|
| | potential |
| Conditions | (mV) |
| CS-opal microparticles in pH 4.1 0.1M sodium acetate buffer | 10.3 |
| CS-opal microparticles in pH 6.7 DIW | −2.7 |
| CS-opal microparticles prepared via degradation of | −1.9 |
| gelatin film at pH 6.7 DIW³ | |

In this section, we examine the zeta potential of CS-opal microparticles having 0.12% w/v CS content prepared via evaporation-neutralization technique in two pH conditions, pH 4.1 and 6.7. We then compare these values to that of the ones prepared via the degradation of gelatin film as reported in our previous study.

For this, two separate batches of PS225-based CS-opal microparticles containing 0.12% w/v CS were prepared via the evaporation-neutralization technique as in FIG. 2. A batch of the CS-opal microparticles was washed twice with 0.1 M sodium acetate buffer (pH 4.1) and incubated in the same buffer (pH 4.1) overnight. Another batch of the CS-opal microparticles was washed twice with DIW containing 0.05% v/v TW 20 (pH 6.7) and incubated overnight. The zeta potential of these two batches of CS-opal microparticles in pH 4.1 and pH 6.7 was measured using a ZetaPALS particle analyzer (Brookhaven, NY, USA) as shown in Table S1.

The zeta potential of CS-opal microparticles incubated overnight at pH 4.1 and 6.7 was measured to be 10.3 and −2.7 mV respectively as shown in Table S1. The zeta potential of 10.3 mV for the CS-opal microparticles at a pH lower than the pKa˜6.4 of CS's primary amine groups confirms the presence of positively charged amine groups in the microparticles that are responsible for the stimuli-responsive behavior as shown in FIG. 6. Next, the zeta potential of −2.7 mV for the CS-opal microparticles in DIW with TW 20 at a pH higher than the pKa (˜6.4) of the CS's amine groups is consistent with the measured zeta potential of −1.9 mV at pH 6.7 for the CS-opal microparticles prepared via degradation of gelatin films as reported in our previous study. It is important to note that in our previous study, the CS in the CS-opal microparticles was not neutralized with IN NaOH, instead prepared by exposing gelatin film containing CS-opal micropatterns to an extreme pH of 0.15. In this study, without the need for a sacrificial layer such as gelatin or multiple washing steps, simple exposure to NaOH allows the preparation of highly uniform CS-opal microparticles while showing similar zeta potential as the ones in our previous study as shown in Table S1. The similar zeta potentials of the CS-opal microparticles prepared in this work compared to those in our previous work³ indicates minimal disruption of the electrostatic interactions between the CS's amine groups and PS's sulfate groups upon the neutralization step with NaOH for the formation of stable polymer networks responsible for the stability of microparticles.

In short, the zeta potential results in Table S1 confirm the presence of positively charged amine groups on CS-opal microparticles at low pH, while at a higher pH, the microparticles maintain a low surface charge.

3. CS-Opal Microparticles with Various Shapes

In FIGS. 9A-9D, we demonstrate the robust and reliable nature of our simple evaporation-neutralization technique to prepare uniform CS-opal microparticles having varied shapes.

For this, photolithographically prepared silicon master molds having square, triangular, hexagonal and circular micropatterns were used to prepare PDMS molds with varied shaped micropatterns as reported in our previous studies. Then, CS-opal micropatterns of various shapes were prepared via evaporative deposition using 30% (w/v) PS230 beads and 0.12% (w/v) CS based aqueous solutions. These CS-opal micropatterns were neutralized using IN NaOH to form CS-opal microparticles as in FIGS. 2A-2D, then were retrieved from the PDMS molds using 5×SSC buffer (pH 7) and imaged using darkfield optical microscopy as shown in FIGS. 9A-9D.

The darkfield optical micrographs (left to right) in FIGS. 9A-9D show CS-opal microparticles prepared with PS230 using PDMS micromolds having square, circle, hexagon and triangle shapes respectively. All four different shapes consistently exhibit high yield (>90%) production as well as uniform bright green color. These results illustrate the robust and reliable nature of our simple evaporation-neutralization technique for high yield and reliable production of uniform CS-opal microparticles.

Effect of refractive index and interplanar distance changes on the peak wavelength shifts from CS-opal micropatterns to CS-opal microparticles in FIGS. 2A-2D

TABLE S2
The Effect of refractive index and interplanar distance changes on the peak wavelength
shifts from CS-opal micropatterns to CS-opal microparticles as in FIGS. 2A-2D.

| Condition | PS170 | PS225 | PS260 |
|---|---|---|---|
| Measured peak wavelength of CS-opal micropatterns (λ₁) (nm) | 390 | 550 | 630 |
| Measured peak wavelength of CS-opal microparticles (λₘₚ) (nm) | 420 | 565 | 650 |
| Estimated peak wavelength (λ₂) of CS-opal microparticles via | 411 | 571 | 651 |
| Bragg-Snell equation assuming water (n_{water} = 1.33) as material in | | | |
| the interstitial space and no change in interplanar distance between | | | |
| the PS beads (nm) | | | |
| Ratio of microparticle size = | 1.02 | 1.01 | 1.01 |
| (approx. diameter of CS-opal microparticle)/(diameter of CS-opal | | | |
| micropattern) (nm) | | | |
| New interplanar distance (D₁) = Diameter of PS beads × Ratio of | 173.5 | 227.5 | 262.5 |
| microparticle size (nm) | | | |
| Estimated peak wavelength (λ₃) of CS-opal microparticles via | 400 | 556 | 636 |
| Bragg-Snell equation assuming air (nₐᵢᵣ = 1.0059) as the material in | | | |
| interstitial space and interplanar distance = D₁ (nm) | | | |
| New estimated peak wavelength (λ₄) of CS-opal microparticles = | 421 | 577 | 657 |
| λ₁ + (λ₃− λ₁) + (λ₂ − λ₁) (nm) | | | |
| λ₄ − λₘₚ (nm) | 1 | 12 | 7 |

$$λ = 1.633 * D * \sqrt{( 1 - ϕ ) * {n}_{spheres}^{2} + ( ϕ ) * {n}_{background}^{2} )} \qquad Equation 1$$

In the modified Bragg-Snell equation of Equation 1, λ is the peak wavelength of the diffracted light by the opal structures, D is the interplanar distance between two centers of spheres, § is the void fraction, which is 0.74 for FCC lattice arrangement, nₛₚₕₑᵣₑₛ is the refractive index of the spherical material (PS), and n_{background} is the refractive index of the material filling the interstitial spaces in the opal structure.

FIG. 2C shows the measured diffraction peak wavelengths of CS-opal micropatterns and microparticles with the resulting peak wavelength shifts (Δλₘₐₓ) of 30 nm for PS170-, 15 nm for PS225- and 20 nm for PS260-based CS-opal microparticles in comparison to their respective CS-opal micropatterns. In this section, we utilized Bragg-Snell equation (Equation 1)-based calculations to investigate the possible effect of refractive index change of the material in the interstitial spaces from air (nₐᵢᵣ=1.0029) for CS-opal micropatterns to water (n_{water}=1.33) for CS-opal microparticles and the change in interplanar distances as shown in Table S2. We then compared the calculated values using Equation 1 to those of the measured peak wavelengths in FIG. 2C to examine the correlation with these theoretical estimations.

In Table S2, the first two rows show the measured peak wavelengths of CS-opal micropatterns and of their corresponding microparticles prepared using PS170, PS225 and PS260. Then, the peak wavelengths of CS-opal microparticles were calculated using Equation 1 assuming that the interplanar distance does not change and the refractive index changes from nₐᵢᵣ=1.0059 to n_{water}=1.33 as shown in the third row in Table S2 resulting in peak wavelength shift of 21 nm compared to those of the CS-opal micropatterns. Next, the effect of swelling of the CS-opal microparticles in DI water leading to change in the interplanar distance was then calculated. For this, the changed or the new interplanar distances (D1) (Table S2, fifth row) upon swelling of CS-opal microparticles in DI water were calculated by first taking the ratio of the diameter of CS-opal microparticles to that of the CS-opal micropatterns as shown in the fourth row in Table S2 using ImageJ software from optical micrographs in FIGS. 2A-B then multiplying the ratios with the actual sizes of PS beads. The new interplanar distances increased by up to 3.5 nm in the case of PS170- and about 2.5 nm in the case of PS225- and PS260-based CS-opal micropatterns, showing swelling of CS-opal microparticles rising from hydration of the CS scaffold. These new interplanar distances (D1) were then used to calculate the diffraction peak wavelengths (λ₃) of CS-opal microparticles, assuming that the refractive index of the material in the interstitial spaces does not change from air (nₐᵢᵣ=1.0059). This resulted in up to 10 nm shift in case of PS170- and 6 nm shift in case of PS225- and PS260-based CS-opal microparticles likely arising from swelling of the underlying CS scaffold.

Finally, the combined effect of both the refractive index change from nₐᵢᵣ=1.0059 to n_{water}=1.33 and the interplanar distance changes was investigated by summing the measured diffraction peak wavelengths of CS-opal micropatterns (λ₁) and the peak wavelength shifts contributed individually by the refractive index change and the interplanar distance changes. The combined effect of the refractive index and the interplanar distance changes resulted in new estimated diffraction peak wavelengths (λ₄) of 421 nm for PS170-, 577 nm for PS225- and 657 nm for PS260-based microparticles. The estimated new diffraction peak wavelengths (λ₄) using Equation 1 was in close correlation to those of the measured peak wavelengths (λₘₚ) as shown by their minimal differences of 1 nm up to 12 nm in the case of PS170- and PS225-based CS-opal microparticles respectively, as shown in the bottom last row of Table S2. This minimal difference between theoretical estimations using the Bragg-Snell equation and the experimentally measured values suggest that both the refractive index change and interplanar distance changes led to peak wavelength shifts of up to 30 nm in comparison to the CS-opal micropatterns.

In sum, the combination of refractive index and interplanar distance changes possibly lead to diffraction peak wavelength shifts of up to 30 nm as observed in the spectral data in FIG. 2C. Effect of refractive index and interplanar distance changes on the peak wavelength shifts from CS-opal microparticles to CS-inverse opal (IO) microparticles in FIG. 7D

TABLE S3
The Effect of refractive index and interplanar distance changes
on the peak wavelength shift from CS-opal microparticles
to CS-inverse opal (IO) microparticles as in FIG. 7D.

| Condition | PS260 |
|---|---|
| Measured peak wavelength of CS-opal microparticles (λₘₚ) (nm) | 650 |
| Measured peak wavelength of CS-inverse opal (IO) microparticles (λᵢₒₚ) (nm) | 370 |
| Estimated peak wavelength (λ_{iop water}) of CS-IO microparticles via Bragg-Snell | 569 |
| equation assuming material filling the voids formed upon PS removal as DI | |
| water (n_{water} = 1.33) (nm) | |
| Ratio of microparticle size = | 0.68 |
| (diameter of CS-IO microparticles)/(diameter of CS-opal microparticles) (nm) | |
| New interplanar distance (D₁) = Diameter of PS beads × Ratio of microparticle | 177 |
| size (nm) | |
| Estimated peak wavelength (λ₁) of CS-IO microparticles via Bragg-Snell | 448 |
| equation assuming no refractive index change compared to CS-opal | |
| microparticles and interplanar distance = D₁ (nm) | |
| New estimated peak wavelength (λ₂) of CS-inverse opal microparticles = | 367 |
| λₘₚ + (λ_{iop water} − λₘₚ) + (λ₁ − λₘₚ) (nm) | |
| λᵢₒₚ − λ₂ (nm) | 3 |

FIG. 7D shows the measured diffraction peak wavelengths of PS260-based CS-IO microparticles (370 nm) and opal microparticles (650 nm), resulting in a peak wavelength shift (A) max) of −280 nm. Upon formation of CS-IO microparticles, all the PS beads in the opal structure are dissolved, leaving behind “soft” water-filled pores in place of hard PS beads. The reduced rigidity of the IO structures resulting from these “soft” water-filled pores leads to shrinkage of the overall CS-IO microparticles compared to the rigid CS-opal microparticles. In short, the dissolution of PS beads in CS-opal microparticles to form CS-IO microparticles results in refractive index and interplanar distance changes, which, in turn, causes a substantial wavelength shift as shown in FIG. 7D. In Table S3, we used the Bragg-Snell equation (Equation 1)-based calculations to investigate the possible effect of interplanar distance and refractive index changes contributed by the dissolution of PS beads (n_{PS}=1.59) to form water (n_{water}=1.33) filled pores upon formation of CS-IO microparticles, leading to a large peak wavelength shift of −280 nm, as shown in FIG. 7D. We then compared the calculated values using Equation 1 to those of the measured peak wavelengths in FIG. 7D to examine the correlation with these theoretical estimations.

In Table S3, the first two rows show the measured peak wavelengths of CS-opal and -IO microparticles, as shown in FIG. 7D. Then, the peak wavelength of CS-IO microparticles was calculated using Equation 1, assuming that the interplanar distance does not change while varying the refractive index of the spherical material from PS beads (n_{PS}=1.59) to water (n_{water}=1.33), leading to an −81 nm (569 nm vs. 650 nm) peak wavelength shift in comparison to the CS-opal microparticles, as shown in the third row of Table S3.

Next, to estimate the magnitude of shrinkage of the microparticles on the dissolution of PS beads, we first calculated the ratio of the diameters of the CS-IO microparticles to that of the CS-opal microparticles, obtained using ImageJ analysis from darkfield micrographs in FIGS. 7B and 2B, respectively, as shown in the fourth row of Table S3. The resulting ratio of diameters of 0.68, as shown in the fourth row of Table S3, clearly shows shrinkage of the CS-IO microparticles in comparison to that of the CS-opal microparticles. This shrinkage ratio was multiplied by the PS bead size (260 nm) to obtain the new interplanar distance (D1) in the CS-IO microparticles of 177 nm, as shown in the fifth row of Table S3. This result clearly shows the drastic reduction in the interplanar distance from 260 nm in CS-opal microparticles to that of 177 nm in CS-IO microparticles, caused by the dissolution of PS beads that led to a reduction in the overall size of the microparticles. Using the new interplanar distance (D1=177 nm) and assuming no change in the refractive index in comparison to that of the CS-opal microparticles, the resulting estimated peak wavelength (λ₁) using Equation 1 is 448 nm, as shown in the sixth row of Table S3. The difference between the estimated peak wavelength (λ₁) of CS-IO microparticles of 448 nm and the measured peak wavelength of the CS-opal microparticles of 650 nm is-202 nm, clearly showing the effect of interplanar change upon the dissolution of PS beads from CS-opal microparticles.

Finally, the combined effect of the refractive index and the interplanar change is estimated by summing the measured peak wavelength of CS-opal microparticles (Δₘₚ=650 nm) and the peak wavelength shifts contributed by the refractive index change (Δλ=−91 nm) and interplanar change (Δλ=−202 nm), leading to an estimated peak wavelength of 367 nm for CS-IO microparticles, as shown in the seventh row of Table S3. The minimal difference of 3 nm between the estimated peak wavelength of CS-IO microparticles using Bragg-Snell equation (Equation 1) and that of the measured values shown in FIG. 7D suggests that the combined effect of the refractive index and interplanar distance changes led to observed peak wavelength shifts of up to −280 nm in comparison to the CS-opal microparticles.

In short, the combination of refractive index and interplanar distance changes on dissolution of PS beads possibly lead to diffraction peak wavelength shift of −280 nm as observed in the spectral data in FIG. 7D.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A microparticle, comprising a polymeric core; and chitosan.

2. The microparticle of claim 1, wherein the polymeric core comprises polystyrene.

3. The microparticle of claim 1, wherein the microparticle is spherical, cuboid, pyramidal, or a hexagonal prism.

4. The microparticle of claim 1, wherein the microparticle has a diameter of 50-300 μm.

5. The microparticle of claim 1, wherein the microparticle has a diameter of about 50 μm, about 60 μm, about 70 μm, about 80 μm, about 90 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, or about 300 μm.

6. The microparticle of claim 2, wherein the microparticle has a diameter of about 170 μm, about 225 μm, or about 260 μm.

7. The microparticle of claim 1, wherein the microparticle has a diameter of about 100 μm.

8. The microparticle of claim 1, wherein the chitosan encapsulates the polymeric core.

9. The microparticle of claim 1, wherein the microparticle has been treated with a base (e.g., a hydroxide base).

10. The microparticle of claim 1, wherein the microparticle has been treated with 1 M sodium hydroxide.

11. The microparticle of claim 1, further comprising an active agent (e.g., a biologically active agent, such as a drug).

12. A method of making the microparticle of claim 1, comprising the steps of:
i) contacting a mold with a solution comprising a solvent, a plurality of polymeric beads, and chitosan;
ii) evaporating the solvent, thereby forming a polymeric bead-chitosan micro pattern;
iii) contacting the polymeric bead-chitosan micro pattern with a base; and
iv) neutralizing the base.

13. The method of claim 12, further comprising contacting the microparticle with an active agent.

14. The method of claim 12, wherein the base is aqueous sodium hydroxide.

15. The method of claim 12, wherein the micro pattern is circular, square, hexagonal, or triangular.

16. The method of claim 12, wherein the method is performed at a humidity greater than about 80%, about 85%, about 90%, or about 95%.

17. The method of claim 12, wherein the method is performed at a humidity greater than about 90%.

18. The method of claim 12, wherein the method is performed at a humidity greater than about 93%.

19. The method of claim 12, wherein step iii) further comprises contacting the polymeric bead-chitosan micro pattern with an aqueous solution of polysorbate 20 subsequent to contacting the contacting the polymeric bead-chitosan micro pattern with the base.

20. The method of claim 19, wherein the polymeric bead-chitosan micro pattern is contacted with the solution of aqueous solution of polysorbate 20 at least three times.
